(19) United States
(12) Patent Application Publication
(10) Pub. No.: US 2011/0218817 A1
(43) Pub. Date: Sep. 8, 2011

(54) Method for carrying out clinical studies and method for establishing a prognosis model for clinical studies

(76) Inventor: René Spiegel, Basel (CH)

(21) Appl. No.: 13/128,695

(22) PCT Filed: Nov. 11, 2009
(86) PCT No.: PCT/EP2009/064951

§ 371 Date: May 11, 2011

(30) Foreign Application Priority Data
Nov. 12, 2008 (CH) 01765/08

(51) Int. Cl. G06Q 50/00

(52) U.S. Cl. 705/2

(57) ABSTRACT

A method for planning and carrying out clinical studies, wherein, during and after the end of a predetermined period, values of a predefined target criterion of control persons of a virtual control group are compared with values of the predefined target criterion of test persons of a test group which received a treatment to be investigated. The values of the predefined target criterion of the control persons of the virtual control group during and after the end of the predetermined period are determined from starting characteristics values assigned to the control persons.

The present invention relates to a method for carrying, out clinical studies with novel active principles, more particularly drugs, for patients with progressive, ultimately fatal diseases, for example Alzheimer's disease, and also to a method for establishing a prognosis model for clinical studies in such indications.

A clinical phase, i.e., symptomatic phase, for example of Alzheimer's disease (AD), which is manifested as dementia in advanced stages, is preceded by a preclinical phase lasting for years in which there are slow and increasingly pathological changes in parts of the brain, such changes not being initially perceived by the affected individual in day-to-day life and not being apparent to other people.

Numerous longitudinal studies on older and elderly persons are in progress, in which very early changes in the brain and early markers of Alzheimer's disease can be recorded by means of different test methods and, for example, genetic, biochemical, electrophysiological, imaging, and neuropsychological markers. Initial results are available from these studies, and further findings regarding the natural (spontaneous) course of this disease can be expected in the coming years. An example of such a study is the ADNI (Alzheimer's Disease Neuroimaging Initiative; http://www.ADNI-info.org), a longitudinal study, supported by 56 institutes in the USA, of large samples from healthy elderly persons, patients with what is known as mild cognitive impairment, and patients with AD.

Already today, there are prospects of not only recording the pathological event of AD at an early stage, but also being able to slow or arrest it by timely pharmacological interventions, meaning that the clinical phase, i.e., symptomatic phase, of the disease can be delayed, attenuated, or completely prevented.

DMDs (disease-modifying drugs) are understood to mean substances or active principles which are suitable for the treatment of preclinical (presymptomatic) stages, or else very early, mild stages, of neutodegenerative diseases, also known as MCI (mild cognitive impairment) in the case of AD. Such substances are being developed worldwide in many pharmaceutical companies and academic laboratories.

DMDs ought to act on the disease process in the brain and, in the preclinical stage, initially have no clinically identifiable effect on the symptoms. In mild stages of a disease, for example MCI in the case of AD, there is presumably no immediately occurring effect on the symptoms; their effect becomes clinically identifiable only after a relatively long duration of use (years). “Identifiable” means recordable and quantifiable in a traditional manner, by means of comparisons between treated subjects and untreated subjects or placebo-treated subjects.

In the case of AD or of MCI, according to current assumptions, the duration of use of DMDs is at least 18 months before an effect on the course of the preclinical or of the very early clinical stage of the disease becomes discernible with some certainty, (Vellas B, Andrine S, Sampaio C et al (2007): Disease-modifying trials in Alzheimer's disease: a European task force consensus. Lancet Neurol 6: 56-62). Clinical studies of phases 2 and 3 with novel DMDs thus have to provide a duration of treatment of at least 18 months per patient in order—if positive—to be able to assert the claim of a “disease-modifying effect”. In phase 2, several hundreds of patients normally take part in the clinical studies, and in phase 3 it may be several thousands.

Although the target population for DMDs, viz. patients with preclinical or very early AD, exhibit either no clinical symptoms or only very mild clinical symptoms (MCI), use of a placebo in clinical tests with hundreds or thousands of these patients is ethically difficult to justify in view of the foreseeable malign course of such diseases (Council for International Organzations of Medical Sciences: International Ethical Guidelines for Biomedical Research Involving Human Subjects; Geneva 2002). However, nowadays regulatory authorities such as the FDA or EMEA require double-blind, placebo-controlled studies for the demonstration of action of many drugs, more particularly also of neuropsychotropic drugs, which include the DMDs.

Study designs which are ethically easier to justify and which contain a so-called escape clause to protect the patients in the case of lack of effect or in the case of poor tolerance of an experimental substance or of placebo—often with switching of the patient to symptomatic treatment—are not a satisfactory solution. They involve—similar to placebo-controlled studies in general—a selection bias a priori, since not all patients or subjects are prepared to take part in a study in which they possibly receive a pharmacologically ineffective placebo over a long period. Also, in many cases, for example AD, there is a lack of evidence to date that symptomatically effective drugs, such as cholinesterase inhibitors for example, show a favorable effect in preclinical stages of the disease and can thus be of use as escape medication (Aisen PS: Treatment for MCI: Is the evidence sufficient? Neurology 70: 2020-2021, 2008). So-called add-on designs, i.e., the testing of novel preparations on patients who additionally receive base medication acknowledged as effective in the indication concerned, are also problematic. Firstly, because in many cases, for example in the case of AD, there is a lack of evidence that the current, predominantly symptomatically effective drugs are suitable for treating preclinical stages of the disease concerned (Aisen 2008, see above); secondly, because all add-on studies have the fundamental problem of pharmacokinetic and pharmacodynamic interactions.

The “International Conference on Harmonisation of Technical Requirements for Registration of Pharmaceuticals for Human Use (ICH)” mentions in its “ICH Harmonised Tripartite Guideline” published on Jul. 20, 2000 under the number E10, “Choice of Control Group and Related Issues in Clinical Trials”, the possibility of using an external or historical control group for carrying out a clinical test. However, it is pointed out here that, when the control persons are not selected from the same group as the test persons, the results are to be used only with caution. Similarly, care should be taken that, when using external (historical) control persons, these control persons and also the environmental conditions match very precisely those of the test persons.

There are thus contradictory requirements with respect to the use of (placebo-) control groups, firstly from regulatory authorities, and secondly from the patients, their representatives, and the ethical guidelines. Even by the introduction of an escape clause or by the use of an add-on design, they cannot be reconciled. Against this background, it is an object of the invention to avoid the disadvantages of the known study designs and, more particularly, to provide a method for carrying out clinical studies, for example with DMDs for preclinical stages of AD, which
a) ensures the treatment with an active principle regarded as promising, for example a novel drug, for all subjects taking part in the study,
b) avoids at the same time the disadvantages, more particularly placebo effects, spontaneous improvements, and other temporal effects, of an open, uncontrolled study,
c) prevents or reduces the selection bias relevant especially in long-term studies with simultaneously treated placebo groups, and
d) is more cost-effective than existing studies.

This object is achieved by the processes defined in the independent claims. Further embodiments can be found in the dependent claims.

In a method according to the invention for carrying out clinical studies, a test group, corresponding to the hypothesis of the treatment to be tested and to current knowledge about the disease in question, for example AD, of test persons in preclinical (MCI) or very mild stages of the disease is initially defined. Following the determination of the relevant (medical, neurophysiological, neuropsychological, biochemical, etc.) baseline values, the test persons are administered a treatment, more particularly a drug treatment, over a predetermined period. The values of at least one predefined target criterion of the test persons of the test group are determined at least once up to the end of the predetermined period. Here and below, mention is made in each case of a target criterion; but it is of course equally possible to determine multiple target criteria in each case.

The target criterion can be, in particular, a neuropsychological measurement instrument and/or a behavioral criterion and/or also neurobiological or neurophysiological variables.

In parallel to this, the values of the at least one predefined target criterion of control persons, who did not receive the treatment, are determined at least once up to the end of the predetermined period. However, according to the invention, there are no real control persons. The values of the target criteria are not determined on a real control person, but determined by means of a prognosis model (algorithm) from the baseline characteristics values assigned to the control persons. The control persons are virtual and form a virtual control group. Finally, the values, determined up to the end of the predetermined period, of the predefined target criterion of the virtual control persons are compared with those of the real test persons.

Owing to the process according to the invention, a comparative study can be done without real persons affected by the disease having to forgo treatment with the active principle to be investigated.

Up to the end of the predetermined period, the value of the target criterion of the test persons can be determined not only before the beginning and after the end of the predetermined period of the treatment, but also multiple times during the period of the duration of treatment. Similarly, in the case of the (virtual) control group, the value of the target criterion can also be calculated multiple times based on the prognosis model up to the end of the predetermined period. Ideally, the number of determinations of the values of the target criteria of the test persons matches the number of determinations for the control persons.

In parallel to the virtual control group, additional real control persons of a real control group can receive a placebo treatment over an ethically acceptable, limited, initial time span. In this way, the concerns expressed in the ICH publication Of Jul. 20, 2000 (cf. page 4) with respect to comparisons with external and historical control groups can be addressed. The values of the at least one predefined target criterion of the real control persons of the real control group are then determined after the end of the limited, initial time span and compared with the values, determined after the end of this time span, of the at least one predefined target criterion of the virtual Control persons of the virtual control group.

It is self-evident that the values of the at least one predefined target criterion can be determined not only before and after the end of the limited, initial time span, but that also one or more determinations during this time span are possible.

The limited, initial time span is preferably 6 months, but other time spans are likewise conceivable.

Based on the abovementioned comparison of the values of the target criterion of the virtual control persons with the values of the target criterion of the additional real control persons, the prognosis model can, if necessary, be corrected.

The values of the baseline characteristics of the control persons preferably correspond to the real values of the baseline characteristics of the test persons. Thus, the virtual control group at the starting time of the clinical study has values of the baseline characteristics which are identical to those of the test group.

Thus, it is possible, based on values of the baseline characteristics of the test persons, to form a virtual control group. By means of this control group, it is then possible to compare the values of the predetermined target criteria of the virtual control persons over the course of the predetermined period with the real values of the predetermined target criteria of the test persons. Alternatively, the group of the test persons can also be divided so that, for example, one half of the test persons receives a treatment A and the second half of the test persons receives a treatment B. The control group can be formed from the undivided test group, or two or more control groups can be formed. The values of the target criteria over the course of the predetermined period can, independently thereof, be compared with those of the virtual control persons. However, it is also conceivable for the target criteria of the virtual control persons to be determined starting from a pool of persons which does not match or only partially matches the test group.

The test group should comprise a number of test persons which is appropriate to the problem of the study, more particularly to the type of disease and intervention. This number may depend on the frequency of the occurrence of the disease of interest, but also on the expected effectiveness (effect size) and/or the tolerability of the active principle investigated. Likewise, this number may also be prescribed by the appropriate regulatory authorities. Naturally, any other number is also possible.

A ratio of 1:1 of the number of control persons to the number of test persons is found in many clinical studies with novel therapeutic active principles. However, other ratios, for example with multiple control persons per test person are by all means possible, for example, when, owing to the baseline characteristics, the target criteria are determined in parallel with more than one mathematical model, or when further virtual control persons based on data from further real persons are considered, whose baseline characteristics are comparable with the baseline characteristics of the test person. This makes it possible to gauge possible tolerances of the prognosis model and/or the inaccuracies in the determination of the target criteria or of baseline characteristics, which may have an influence on the prognosis model.

The therapeutic principles to be investigated are preferably a treatment of diseases with a presumably malign course, for example dementia, more particularly AD. It is of course also possible with this method to carry out studies for treating other diseases in which a prolonged administration of placebo is ethically and medically problematic.

The predefined target criterion may also be a multiplicity of predefined target criteria which are determined and compared. Critical for the type and number of target variables is the problem of the study, more particularly the effect expected by the intervention investigated.

In the case of neurodegenerative diseases, for example AD, the target criteria are typically selected from the following groups:
parameters of the central nervous system, more particularly neuropsychological performance characteristics, as recorded, for example, using the CERAD battery (Morris J C, Heyman A, Mohs R C et al. (1989) The Consortium to Establish a Registry for Alzheimer's Disease (CERAD): I: clinical and neuropsychological assessment of Alzheimer's disease. Neurology 39: 1159-1169) and similar instruments,
data from tests according to the ADNI database (Alzheimer's Disease Neuroimaging Initiative, www.loni.ucla.edu/ADNI), hereinafter referred to as ADNI database,
subjective and objective dementia symptoms, for example handicaps in daily life which can be recorded and quantified using ADL and IADL scales (Galasko D, Bennett D, Sano M, et al. An inventory to assess activities of daily living for clinical trials in Alzheimer's disease. Alzheimer Dis Assoc Disord. 1997; 11(Suppl 2): S33-S39.),
changes in the brain, more particularly shrinkages of the hippocampus as a whole and/or shrinkages of certain sections of the hippocampus or other brain regions, vascular pathology, and similar changes,
markers in the cerebrospinal fluid, such as, for example, Abeta, tau, quotients of Abeta and/or other markers,
the presence of pathological proteins, such as Abeta and/or tau, in other body fluids,
further biochemical and genetic markers,
psychiatric and motor abnormalities.

A target criterion often used in studies on presymptomatic patients is “time to event”, i.e., the time in days, weeks, or months which elapses from the patient joining the study up to a relevant clinical event occurring for the first time, for example a heart attack or stroke, in the case of MCI preferably the first-time diagnosis of “dementia”, by the clinicians concerned.

The baseline characteristics typically comprise at least one target criterion and/or are, in the case of AD, selected from the group:
age of the patient,
the presence of the E-4 allele of the apolipoprotein gene and/or other genetic or biochemical markers,
the intelligence recorded in childhood or adolescence or an equivalent thereof, the duration of education and/or the professional career,
life-style factors in middle age, for example die physical activity, sport and/or other activities,
clinical characteristics and diagnoses, such as obesity, hypertension, diabetes and/or hyperlipidemia, which may also be summarized in an overall clinical score,
traumatic events such as stroke and accidents which may temporarily or permanently influence brain function
functional parameters of the human heart or other organs of the human body,
personal characteristics, such as neuroticism and/or conscientiousness.

Further baseline characteristics are also conceivable.

A method according to the invention for establishing a prognosis model for clinical studies-comprises the steps of:
a) collecting representative results from clinical studies with untreated patients concerning the course of a disease of interest,
b) evaluating these results,
c) identifying at least one target criterion which is clinically relevant for the course of the disease of interest and can be used as a predefined target criterion in a subsequent study,
d) determining the change in the value of this at least one target criterion for a certain number of patients and over a certain period,

so that, by means of this determination in step d), it is possible to prepare a prognosis for the temporal change in the value of this target criterion based on values of baseline characteristics for a patient or for patient groups.

To establish the prognosis model, results of a sufficient number of persons who were observed during a sufficiently long period of the preclinical phase of the disease concerned should be collected and evaluated. This number may vary depending on the type and frequency of the disease of interest, and so it may be possible to establish a prognosis model with a rather low or relatively large number of results. A suitable, comprehensive data set is provided by the ADNI (Alzheimer's Disease Neuroimaging Initiative) mentioned at the beginning.

Depending on the disease, a multiplicity of target criteria, but also only one target criterion, can be identified.

The target criteria and the baseline characteristics are defined in the same way as described above for the method for carrying out clinical studies.

Although, in the present case, the invention has been predominantly illustrated by reference to AD, the method is by no means restricted thereto, but is also applicable for carrying out clinical studies and establishing a prognosis model for clinical studies of other diseases.

The invention is explained in more detail below with reference to exemplary embodiments and figures. Here:

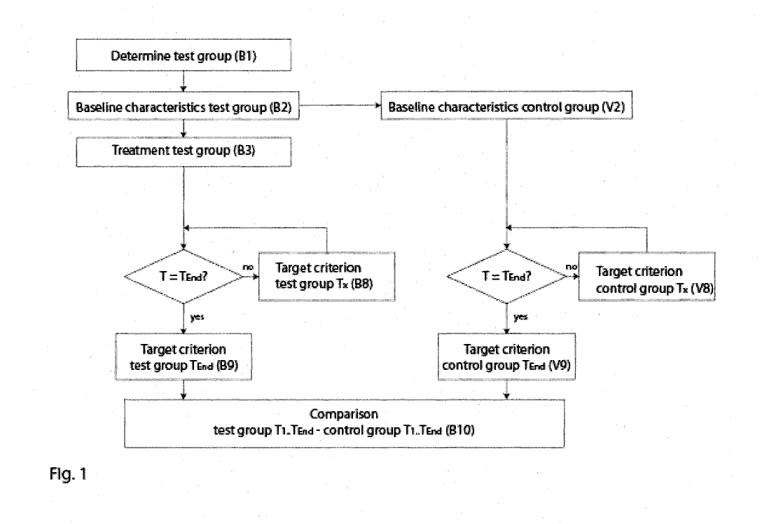

FIG. 1: shows a flowchart of a method for carrying out clinical studies,

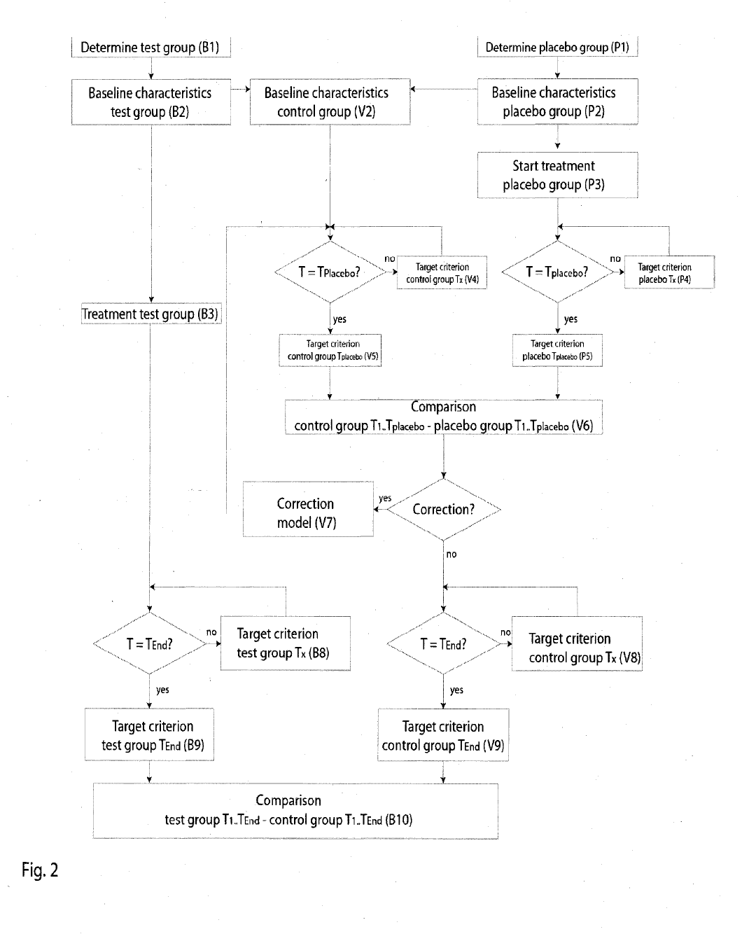

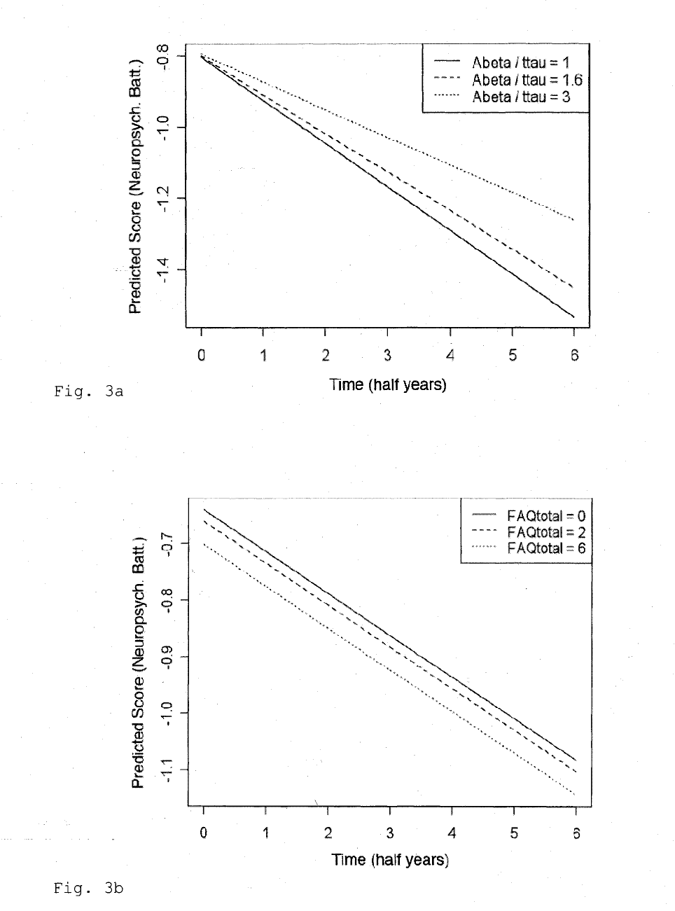

FIG. 2: shows a flowchart of an alternative method for carrying out clinical studies with an initial, temporally limited placebo control group,

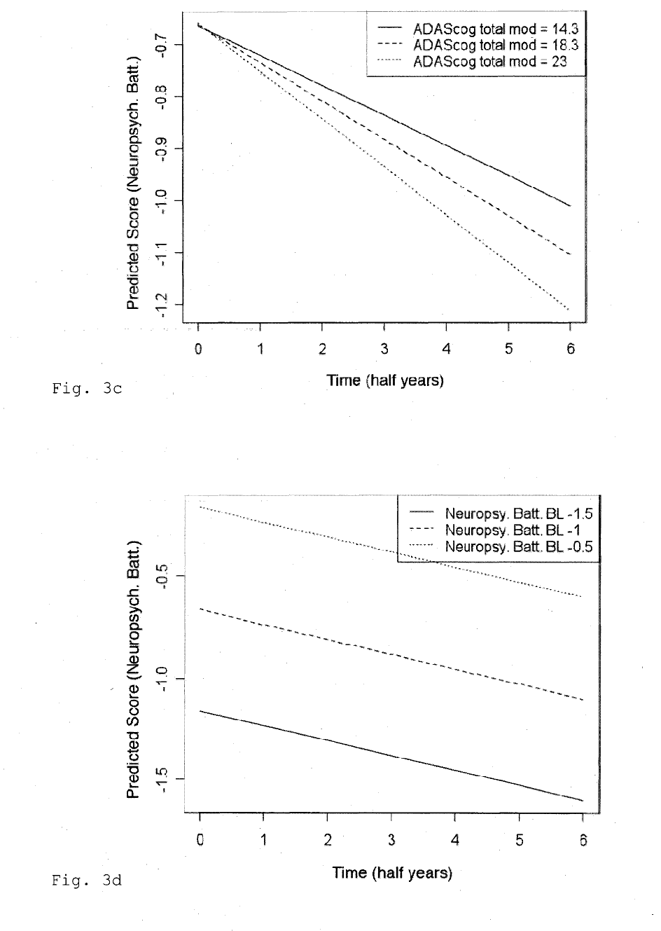

FIGS. 3a-3d: graphically depict scores of the neuropsychological test battery froth the ADNI database over the course of time as a function of 4 different baseline characteristics, determined by means of a first example calculation,

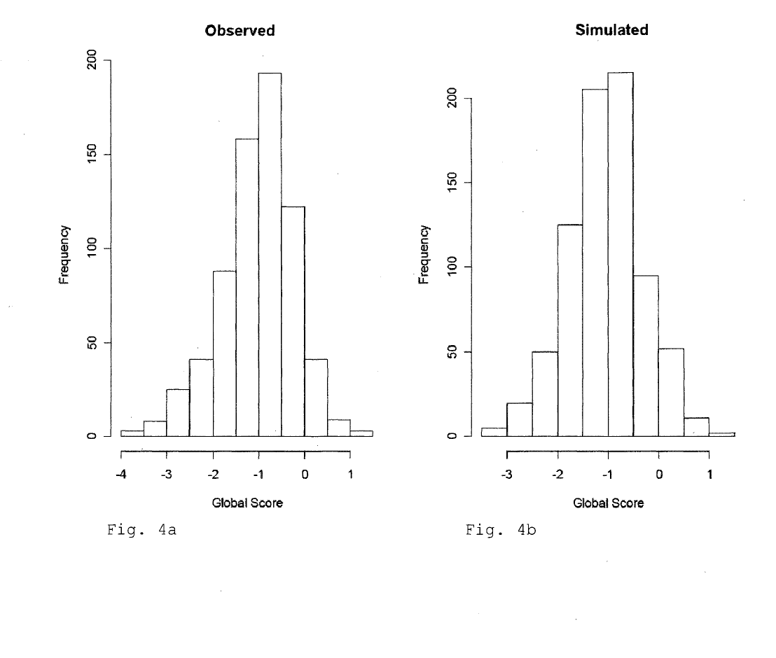

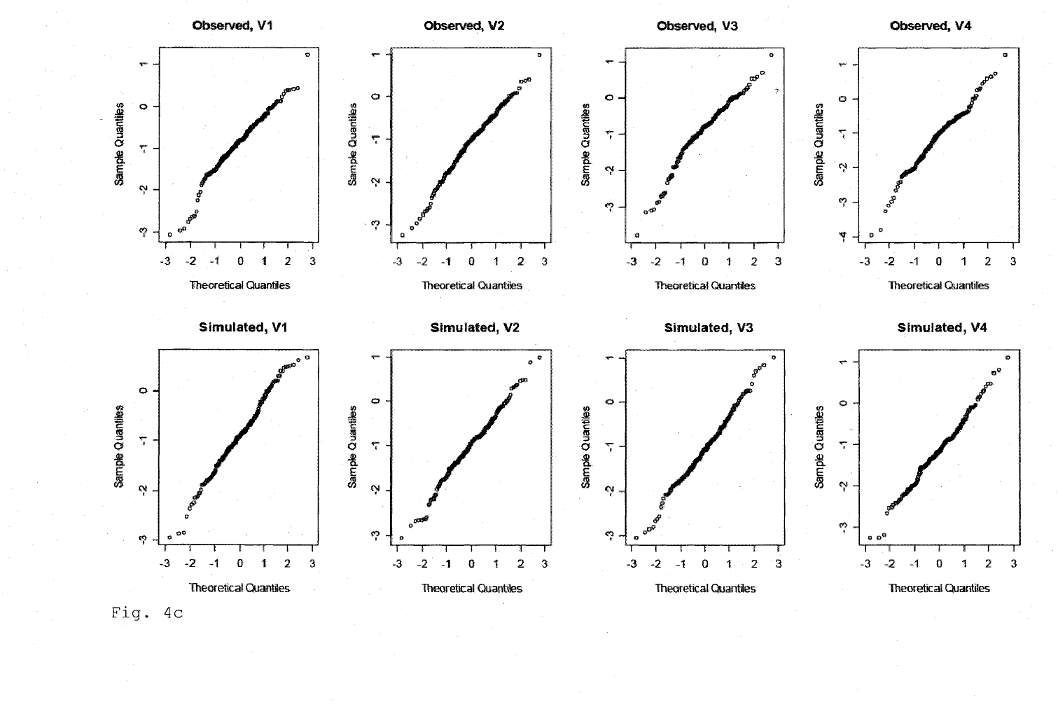

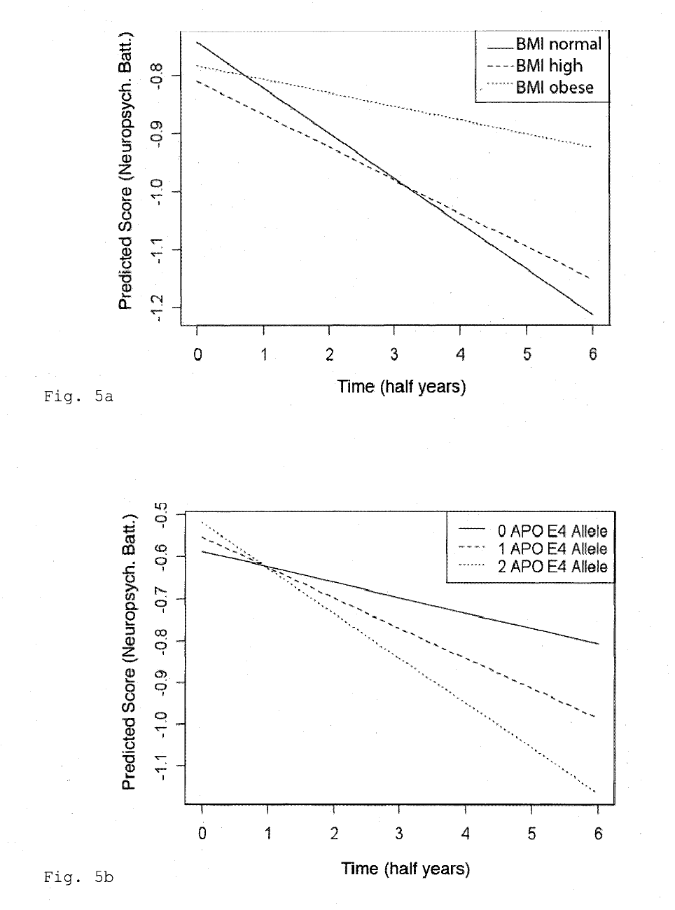

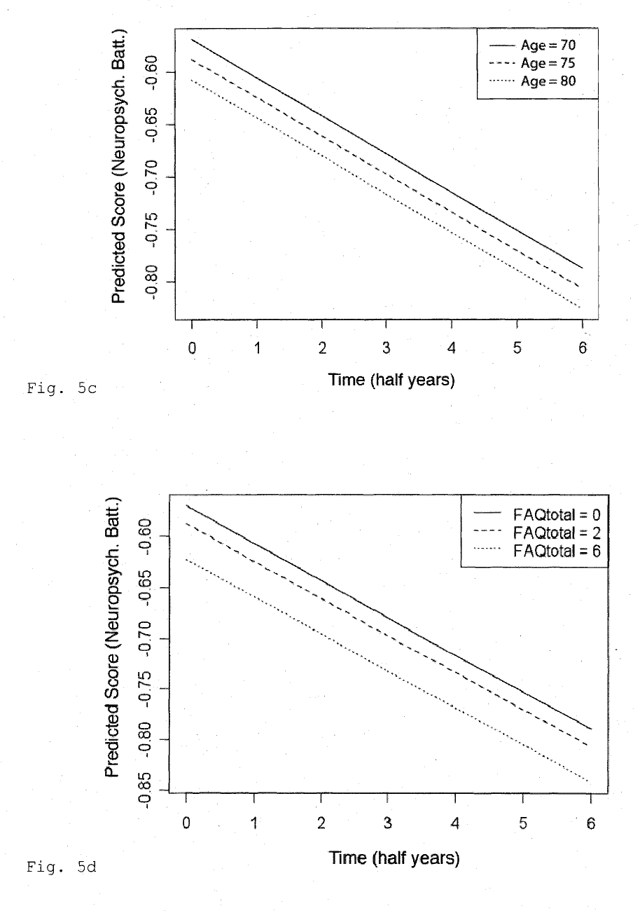

FIGS. 4a-4c: show the distributions of the observed and simulated data based on a first example calculation in two histograms and in QQ plots,

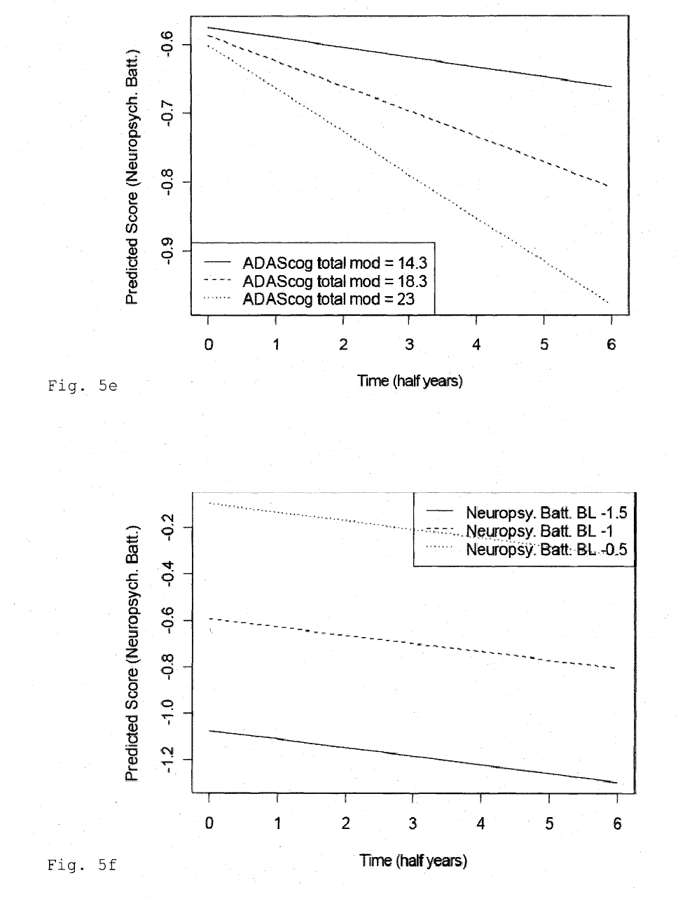

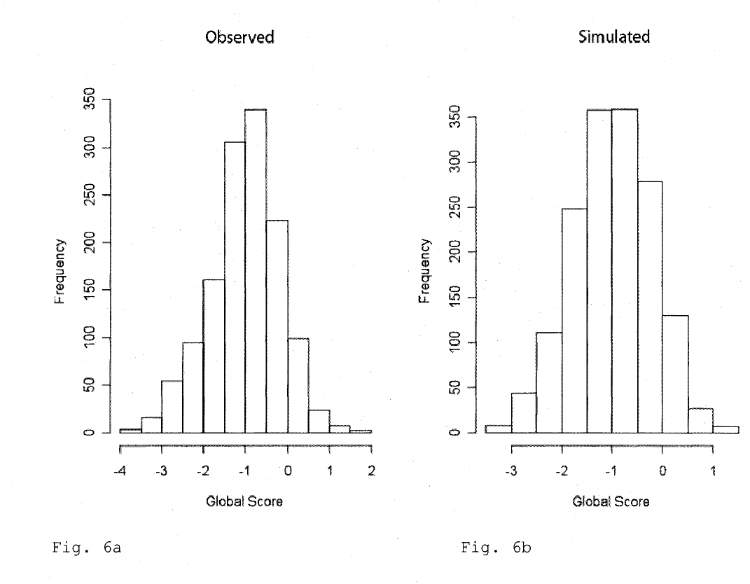

FIGS. 5a-5f: graphically depict scores of the neuropsychological test battery from the ADNI database over the course of time as a function of 6 different baseline characteristics, determined by means of a second example calculation, and

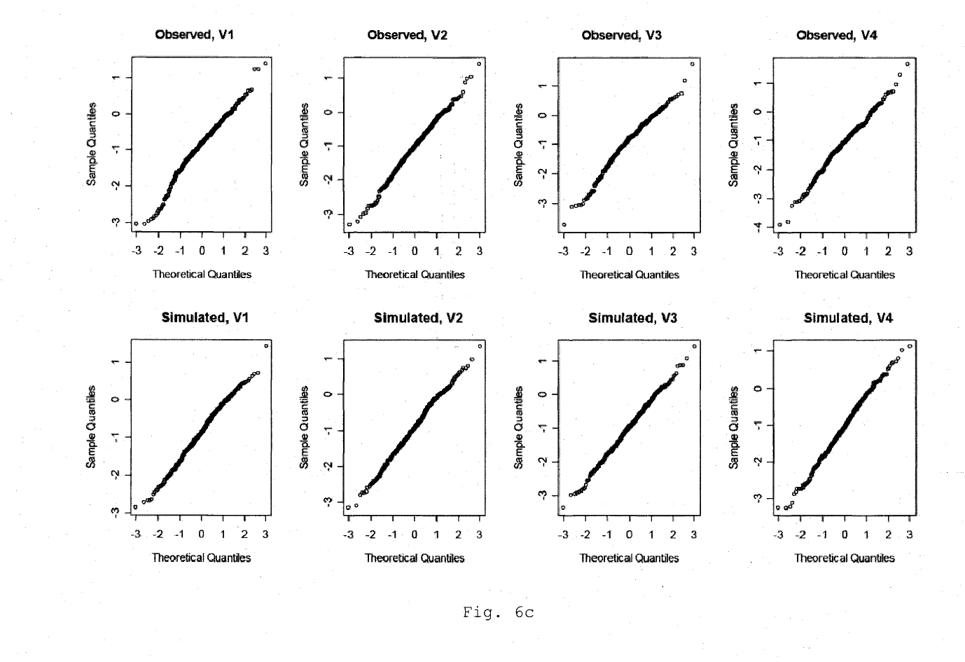

FIGS. 6a-6c: show the distributions of the observed and simulated data based on a second example calculation in two histograms and in QQ plots.

FIG. 1 depicts a flowchart which shows a method according to the invention for carrying out clinical studies. A first step B1 defines the test group of the test persons which is to receive a treatment for the disease of interest. The baseline characteristics of the test persons are determined in step B2. Based on these baseline characteristics of the test persons, baseline characteristics of a virtual group of control persons are then defined in step V2. Determination of the control persons based on other baseline characteristics is likewise conceivable.

The test persons then receive the corresponding treatment B3 during a predetermined period up to time T_{End}. During this time, the value of at least one target criterion is determined in step B8 at a regular interval, producing a series of values at corresponding times Tₓ.

At the same time, likewise at regular intervals in step V8, the value of at least one target criterion of the control persons is calculated by means of the baseline characteristics of the control persons by means of a prognosis model (algorithm). A series of values which correspond to the corresponding times Tₓ is likewise produced.

After the end of the predetermined period, i.e., at time T_{End}, the target criteria both of the test persons and of the control persons are determined or calculated again in steps B9 and V9.

In the last step B10, the values of the target criteria at times T₁ . . . T_{End} of the test persons are then compared with the calculated values of the virtual control persons and the study results can be evaluated. Here, use can be made of the statistical methods suitable for comparative studies between two or more parallel groups (e.g., t-test, variance analysis with adjustment, mixed models, logistic regression, GEE models, Cox PH regression). The test level should be adjusted according to methods for sequential procedures.

FIG. 2 shows a flowchart of a modified method for carrying out clinical studies. In addition to the test group and virtual control group described in FIG. 1, a placebo group is also defined in step P1. A placebo group is understood to mean a real, temporally limited control group which receives a placebo treatment over an initial time span, up to the end of T_{placebo}.

The baseline characteristics of a virtual group of control persons are determined in step V2 based on the baseline characteristics of the test persons, which were determined in step B2, and the baseline characteristics of the placebo group, from step P2. The baseline characteristics of the control persons may also be determined differently.

During the treatment of the test group in step B3, the placebo group receives correspondingly a placebo treatment P3 over the initial time span until T_{placebo} is reached. The time span T_{placebo} here is smaller than the predetermined period up to time T_{End}.

At a regular interval, the value of at least one target criterion is,then determined in steps V4 and P4, respectively, each producing a series of values at corresponding times Tₓ. It should be noted here that the values of the control group are calculated by means of a prognosis model from the values of the baseline characteristics.

After the end of T_{placebo}, the values of the corresponding target criterion are determined again in steps V5 and/or V6 before these values of the target criteria T₁ . . . T_{placebo} of the control persons are compared with those of the placebo group in step V6. Subsequently, it is decided whether a correction of the prognosis model is necessary, or whether the values exhibit sufficient agreement. If a correction is required, the prognosis model is correspondingly adapted in step P7 and the values of the target criteria T₁ . . . T_{placebo} of the control persons are calculated again. After the end of the predetermined placebo phase, the subjects of this group can likewise receive the active principle (drug) investigated. The measured values gathered in this group can be statistically evaluated separately, but do not have to be part of the comparison between the test group and virtual control group.

Subsequently, in step V8, the values of the target criterion are further calculated at regular intervals up to the end of the predetermined period, up to time T_{End}.

In parallel to steps V4-V8 and P3-P5, the test group receives the corresponding treatment B3 to be investigated. Here as well, the values of at least one target criterion of the test persons are determined at regular intervals, ideally at the same times as in steps V5 and V8; see step B8.

After the end of the predetermined period, i.e., at time T_{End}, the target criteria both of the test persons and of the control persons are determined or calculated again in steps B9 and V9.

In the last step B10, the values of the target criteria at times. T₁ . . . T_{End} of the test persons are then compared with the calculated values of the virtual control persons and the study results can be evaluated. Here, use can be made of the statistical methods suitable for comparative studies between two or more parallel groups (e.g., t-test, analysis of variance with adjustment, mixed models, logistic regression, GEE models, Cox PH regression).

Typical target criteria can be
end points, i,e., previously defined values of tests, scales, or else biological measured values, which are considered to be significant for the disease investigated;
slopes, i.e., characteristics of progress curves which characterize the development of the disease investigated with time
time to event (cf. page 10), i.e., the time which elapses from the patients joining the study up to events regarded as clinically relevant occurring.

To determine by calculation the target criteria of the control group, use is made of suitable prognosis models. Effects of individual factors (i.e., baseline characteristics) on the course of AD, and also models for quantitative estimation of the risks of developing AD, are known. The present invention is able to use, as possible starting points, models according to the findings of Kivipelto (Prognostic models for cognitive impairment and midlife risk, S4-03-04), Wilson (Personality and risk of cognitive impairment in old age, S4-03-01), Bennett (Brain reserve: the epidemiological perspective, PL-05-01), all from abstracts for the “Alzheimer's Association International Conference on Alzheimer's disease”, Jul. 26-31, 2008, Chicago Ill., The Journal of the Alzheimer's Association, Vol. 4, Issue 4, Suppl. 2, July 2008).

The target criteria can be typically determined as shown in the following two example calculations with data from the ADNI database.

According to a first model, for patients with MCI, changes in the global scores of the ADNI neuropsychological test battery (“Neurobat”) with time are estimated, with adjustment for demographic variables and cognitive variables at the start of the study (predictors at baseline=b1). The changes are determined as slopes.

At the end point, the global score of Neurobat (variable: nbatglob) is determined as a target variable.

As an intra-patient factor, time is considered, measured in periods of six months (variable nviscode (0=b1, 1=6 mon, 2=12 mon, . . . 6=36 mon)).

The following predictors are considered as baseline characteristics:
Sex (variable ptgender, 1=male, 2=female)
Education (variable pteducation, in years)
Age (variable ptage, in years)
BMI at start of study, (variable vsbmicat, categorized as normal (<25, reference), high (25-30), and obese (>30))
Modified Hachinski score at start of study (variable hmscore)
Quotient of Abeta₁₋₄₂/total tau at start of study (variable betaovtau)
Number of ApoE4 genes (variable napgen, 0-2)
Total score of the functional assessment questionnaire (FAQ) at start of study (variable faqtotal, max=50)
MMS (mini-mental state) at start of study (variable mmscore)
ADAScog (Alzheimer Disease Assessment Scale cognitive part) modified total score at start of study (variable totalmodbl max=85)
Global score of Neurobat at start of study (variable: nbatglobbl)

All calculations were carried out in R (R Development Core Team (2007)).

In a first step, a starting model with time, all predictor variables and all interactions with time as fixed effects and with random effects for the patients was used. This makes it possible to determine for each patient a random deviation from the mean value, which value is estimated from the fixed effects. This deviation is treated as a random variable. Its standard deviation is estimated in addition to the standard deviation of the residuals. Furthermore, the model allows for each patient a random deviation of the slope from the slope determined across all patients. For these deviations as well, the standard deviation is estimated.

The cerebrospinal fluid (CSF) is entered as a quotient of Abeta1-42 over total tau. This quotient has been proven, in other studies.

Confidence intervals are displayed for the standard deviation and the correlation of the random effects. Confidence intervals of the fixed effects can be easily determined from the parameter table and are of secondary interest, since Wald tests are available here.

Quadratic effects of time cannot be modelled because too many predictors are in the model. Alternative analyses have shown only a weak quadratic effect which only became clearer in the third year. At present, therefore, no quadratic effects of time are analyzed.

Only about 50% of the MCI patients according tothe ADNI database had CSF values at the start of the study. For individual patients, there was a lack of other baseline data Therefore, in the first example calculation, only 189 patients were included in the analyses.

Linear mixed-effects model fit by REML

Data: MCIba_0

| AIC | BIC | logLik |
|---|---|---|
| 651.1486 | 775.2715 | −298.5743 |

Random effects:

| Formula: | ~1 + nviscode \| rid | |
|---|---|---|
| Structure: | General positive-definite, Log-Cholesky parametrization | |
| | StdDev | Corr |
| (Intercept) | 0.18518363 | (Intr) |
| nviscode | 0.07060092 | 0.514 |
| Residual | 0.25075384 | |

Fixed effects: nbatglob ~ vsbmicat2 + nviscode + hmscore + betaovtau + napgen +
pteducat + ptage + ptgender + faqtotal + mmscore + totalmodbl + nbatglobbl +
nviscode:vsbmicat2 + nviscode:hmscore + nviscode:betaovtau + nviscode:napgen +
nviscode:pteducat + nviscode:mmscore + nviscode:totalmodbl +
nviscode:nbatglobbl

| | | | | | |
|---|---|---|---|---|---|
| | Value | Std. Error | DF | t-value | p-value |
| (Intercept) | 0.8560546 | 0.5964127 | 557 | 1.435339 | 0.1518 |
| vsbmicat2high | −0.0715724 | 0.0553691 | 176 | −1.292641 | 0.1978 |
| vsbmicat2obese | −0.0054378 | 0.0758238 | 176 | −0.071716 | 0.9429 |
| nviscode | −0.0885050 | 0.1734763 | 557 | −0.510185 | 0.6101 |
| hmscore | 0.0315156 | 0.0340266 | 176 | 0.926203 | 0.3556 |
| betaovtau | 0.0042881 | 0.0176467 | 176 | 0.242998 | 0.8083 |
| napgen | 0.0232389 | 0.0408216 | 176 | 0.569280 | 0.5699 |
| pteducat | −0.0003740 | 0.0087864 | 176 | −0.042563 | 0.9661 |
| ptage | −0.0058720 | 0.0032846 | 176 | −1.787750 | 0.0755 |
| ptgender | −0.0502078 | 0.0511771 | 176 | −0.981060 | 0.3279 |
| faqtotal | −0.0093692 | 0.0051685 | 176 | −1.812738 | 0.0716 |
| mmscore | −0.0052058 | 0.0156676 | 176 | −0.332269 | 0.7401 |
| totalmodbl | −0.0021895 | 0.0048945 | 176 | −0.447336 | 0.6552 |
| nbatglobbl | 0.9686973 | 0.0541730 | 176 | 17.881546 | 0.0000 |
| vsbmicat2high:nviscode | 0.0166253 | 0.0196038 | 557 | 0.848068 | 0.3968 |
| vsbmicat2obese:nviscode | 0.0467125 | 0.0274983 | 557 | 1.698740 | 0.0899 |
| nviscode:hmscore | 0.0046822 | 0.0124132 | 557 | 0.377198 | 0.7062 |
| nviscode:betaovtau | 0.0153686 | 0.0062597 | 557 | 2.455182 | 0.0144 |
| nviscode:napgen | −0.0242458 | 0.0143613 | 557 | −1.688268 | 0.0919 |
| nviscode:pteducat | −0.0013945 | 0.0031599 | 557 | −0.441323 | 0.6592 |
| nviscode:mmscore | 0.0019046 | 0.0056013 | 557 | 0.340025 | 0.7340 |
| nviscode:totalmodbl | −0.0026544 | 0.0017326 | 557 | −1.532055 | 0.1261 |
| nviscode:nbatglobbl | 0.0232797 | 0.0197777 | 557 | 1.177067 | 0.2397 |

Standardized Within-Group Residuals:

| | | | | |
|---|---|---|---|---|
| Min. | Q1 | Med | Q3 | Max |
| −5.4769035 | −0.5375011 | 0.0116638 | 0.5243880 | 2.8531692 |

Number of Observations: 756
Number of Groups: 189
Random Effects:

| | | | |
|---|---|---|---|
| Level: rid | | | |
| | lower | est. | upper |
| sd((Intercept)) | 0.1249367 | 0.18518363 | 0.27448291 |
| sd(nviscode) | 0.0506308 | 0.07060092 | 0.09844777 |
| cor((Intercept), nviscode) | −0.5154828 | 0.51433737 | 0.93632619 |

Within-group standard error:

| | | |
|---|---|---|
| lower | est. | upper |
| 0.2336142 | 0.2507538 | 0.2691510 |

The following interactions did not contribute to the prediction and were eliminated in a stepwise process:

nviscode:pteducat

nviscode rmmscore

nviscode:hmscore

nviscode:napgen

nviscode:nbatglobbl

Also, the categories “normal” and “high” of the BMI were combined to form the category “not.obese” because no differences in the parameter estimations were discernible between these two categories.

The stepwise elimination process subsequently excluded the following terms (interaction and variables):

nviscode:vsbmicat3

mmscore

apgen

pteducation

ptgender

Hachinski score

Age

BMI (not obese versus obese)

The above-described simplifying steps produces the following simpler model:

Linear mixed-effects model fit by REML

Data: MCIba_0

| AIC | BIC | logLik |
|---|---|---|
| 539.4807 | 594.8896 | −257.7404 |

Random effects:

| Formula: | ~1 + nviscode \| rid | |
|---|---|---|
| Structure: | General positive-definite, Log-Cholesky parametrization | |
| | StdDev | Corr |
| (Intercept) | 0.18163785 | (Intr) |
| nviscode | 0.06979345 | 0.56 |
| Residual | 0.25115344 | |

Fixed effects: nbatglob ~ nviscode + betaovtau + faqtotal + totalmodbl +
nbatglobbl + nviscode:betaovtau + nviscode:totalmodbl

| | | | | | |
|---|---|---|---|---|---|
| | Value | Std. Error | DF | t-value | p-value |
| (Intercept) | 0.1983170 | 0.09375083 | 564 | 2.115363 | 0.0348 |
| nviscode | −0.0716350 | 0.03346308 | 564 | −2.140717 | 0.0327 |
| betaovtau | 0.0032773 | 0.01535459 | 184 | 0.213440 | 0.8312 |
| faqtotal | −0.0101478 | 0.00507821 | 184 | −1.998296 | 0.0472 |
| totalmodbl | 0.0005787 | 0.00463211 | 184 | 0.124926 | 0.9007 |
| nbatglobbl | 0.9997337 | 0.04373146 | 184 | 22.860741 | 0.0000 |
| nviscode:betaovtau | 0.0222897 | 0.00548279 | 564 | 4.065402 | 0.0001 |
| nviscode:totalmodbl | −0.0039768 | 0.00146246 | 564 | −2.719227 | 0.0067 |

Standardized Within-Group Residuals:

| | | | | |
|---|---|---|---|---|
| Min | Q1 | Med | Q3 | Max |
| −5.54951632 | −0.53529203 | 0.01501314 | 0.52888491 | 2.89043920 |

Number of Observations: 756
Number of Groups: 189
Random Effects:

| | | | |
|---|---|---|---|
| Level: rid | | | |
| | lower | est. | upper |
| sd((Intercept)) | 0.12361124 | 0.18163785 | 0.26690380 |
| sd(nviscode) | 0.05061054 | 0.06979345 | 0.09624724 |
| cor((Intercept), nviscode) | −0.50343814 | 0.55983715 | 0.94874790 |

Within-group standard error:

| | | |
|---|---|---|
| lower | est. | upper |
| 0.2342006 | 0.2511534 | 0.2693335 |

Interaction of Abeta1-42/total tau with time means: the (negative) slope with time becomes attenuated (i.e., less steep) for patients with higher Abeta1-42 and/or lower total tau.

Interaction of ADAScog modified total score with time means: patients with a higher score at the start(=poorer performance) of the study have Steeper decreases.

The residuals of this model do not deviate discernibly from the normal distribution. Therefore, no transformation of the target variables is shown.

The overall modelling error (standard deviation of an individual observation) is between 0.31 (6 months) and 0.52 (36 months).

The lower confidence limits produce the corresponding modelling errors

0.26 (6 months) and 0.40 (36 months)

The upper confidence limits produce the corresponding modelling errors

0.38 (6 months) and 0.69 (36 months)

For comparison: the standard deviation of all global scores (6 to 36 months) is 0.86

The graphs according to FIGS. 3a to 3d illustrate the effect of each predictor over time. The other predictors in each case are fixed as a reference value to their median or their most common value. These reference values are listed as follows:
Abeta₁₋₄₂/Total tau=1.6
faqtotal=2
totalmodbl=18.3
nbatglobbl=−1

FIG. 3a shows the predicted score as a function of time for three different values of Abeta1-42/total tau.

FIG. 3b shows the predicted score as a function of time for three different values of FAQtotal.

FIG. 3c shows the predicted score as a function of time for three different values of ADAScog total mod.

FIG. 3d shows the predicted score as a function of time for three different values of the baseline.

For each subject with complete predictor data (especially CSF present), values are simulated according to the mixed model. Here, initially logarithms of the standard deviations for intercept and slope are simulated per subject. Using the standard deviations obtained in this way, random effects for the intercept and the slope are generated. Furthermore, vector of fixed effects according to the parameter estimations and the covariance matrix thereof is generated for each subject. In addition, an error term is generated for each subject and each time point.

These data were generated completely for visits 1-4. The observed data are not complete. A comparison with each data point is therefore not possible.

The simulated data at no point completely agree with the observed data. However, their overall distribution is similar to that for the observed data. The following distributions were calculated:

Observed Data According to ADNI Data:

| Min. | 1st Qu. | Median | Mean | 3rd Qu. | Max. | NA's |
|---|---|---|---|---|---|---|
| −3.9520 | −1.4630 | −0.9516 | −1.0180 | −0.4975 | 1.2780 | 14.0000 |

SD: 0.7839431

Simulated Data According to First Model:

| Min. | 1st Qu. | Median | Mean | 3rd Qu. | Max. |
|---|---|---|---|---|---|
| −3.2510 | −1.5170 | −1.0570 | −1.0510 | −0.6136 | 1.1020 |

SD: 0.7399358

FIGS. 4a and 4b show the distributions of the observed and simulated data of the global score in two histograms (in each case all visits included) as a comparison. FIG. 4c shows the distributions of the observed and simulated data of the global score per visit in QQ plots.

The simulated data are determined from the model parameters and the predictors available at the start of the study. Upon application to a new study, the same model parameters, but the predictors of the new study participants, are used for the simulation.

In a second example calculation, changes in the global score with time, with adjustment for demographic variables and cognitive variables at the start of the study (predictors), are estimated for a larger number of patients with MCI compared to the first example calculation. The second example calculation essentially corresponds to the first example, but with the quotient of Abeta1-42/total tau at the start of the study (variable betaovtau) not being used as a possible predictor.

The second example calculation also begins with a starting model, as described above, with time, all predictor variables and all interactions with time as fixed effects and with random effects for the patients, i.e., it allows for each patient a random deviation from the mean value, which value is estimated from the fixed effects.

Linear mixed-effects model fit by REML

Data: MCIba_0

| AIC | BIC | logLik |
|---|---|---|
| 1073.724 | 1205.254 | −511.8618 |

Random effects:

| Formula: | ~1 + nviscode \| rid | |
|---|---|---|
| Structure: | General positive-definite, Log-Cholesky parametrization | |
| | StdDev | Corr |
| (Intercept) | 0.19018619 | (Intr.) |
| nviscode | 0.06718466 | 0.661 |
| Residual | 0.24998144 | |

Fixed effects: nbatglob ~ vsbmicat2 + nviscode + hmscore + napgen + pteducat +
ptage + ptgender + faqtotal + mmscore + totalmodbl + nbatglobbl +
nviscode:vsbmicat2 + nviscode:hmscore + nviscode:napgen + nviscode:pteducat +
nviscode:mmscore + nviscode:totalmodbl + nviscode:nbatglobbl

| | | | | | |
|---|---|---|---|---|---|
| | Value | Std. Error | DF | t-value | p-value |
| (Intercept) | 0.2186482 | 0.4046705 | 1061 | 0.540312 | 0.5891 |
| vsbmicat2high | −0.0693033 | 0.0393589 | 363 | −1.760802 | 0.0791 |
| vsbmicat2obese | −0.0405157 | 0.0553292 | 363 | −0.732266 | 0.4645 |
| nviscode | 0.0474761 | 0.1218900 | 1061 | 0.389500 | 0.6970 |
| hmscore | 0.0167155 | 0.0256497 | 363 | 0.651684 | 0.5150 |
| napgen | 0.0355239 | 0.0263572 | 363 | 1.347787 | 0.1786 |
| pteducat | 0.0051555 | 0.0064076 | 363 | 0.804598 | 0.4216 |
| ptage | −0.0039488 | 0.0023259 | 363 | −1.697763 | 0.0904 |
| ptgender | −0.0244486 | 0.0353680 | 363 | −0.691264 | 0.4898 |
| faqtotal | −0.0091341 | 0.0037908 | 363 | −2.409531 | 0.0165 |
| mmscore | 0.0095854 | 0.0109641 | 363 | 0.874254 | 0.3826 |
| totalmodbl | −0.0027840 | 0.0035731 | 363 | −0.779138 | 0.4364 |
| nbatglobbl | 0.9521837 | 0.0355300 | 363 | 26.799457 | 0.0000 |
| vsbmicat2high:nviscode | 0.0199568 | 0.0137361 | 1061 | 1.452874 | 0.1466 |
| vsbmicat2obese:nviscode | 0.0488740 | 0.0203208 | 1061 | 2.405120 | 0.0163 |
| nviscode:hmscore | −0.0016343 | 0.0091400 | 1061 | −0.178805 | 0.8581 |
| nviscode:napgen | −0.0362322 | 0.0093205 | 1061 | −3.887381 | 0.0001 |
| nviscode:pteducat | −0.0050203 | 0.0023201 | 1061 | −2.163857 | 0.0307 |
| nviscode:mmscore | 0.0018276 | 0.0039647 | 1061 | 0.460954 | 0.6449 |
| nviscode:totalmodbl | −0.0049473 | 0.0012680 | 1061 | −3.901703 | 0.0001 |
| nviscode:nbatglobbl | 0.0142686 | 0.0126101 | 1061 | 1.131520 | 0.2581 |

Standardized Within-Group Residuals:

| | | | | |
|---|---|---|---|---|
| Min | Q1 | Med | Q3 | Max |
| −5.510351267 | −0.553693504 | −0.002053127 | 0.540254540 | 3.400516216 |

Number of Observations: 1445
Number of Groups: 375
Random Effects:

Level: rid

| | | | |
|---|---|---|---|
| | lower | est. | upper |
| sd((Intercept)) | 0.1466417 | 0.19018619 | 0.24666092 |
| sd(nviscode) | 0.0529942 | 0.06718466 | 0.08517496 |
| cor((Intercept), nviscode) | −0.2795052 | 0.66135055 | 0.95427510 |

Within-group standard error:

| | | |
|---|---|---|
| lower | est. | upper |
| 0.2376837 | 0.2499814 | 0.2629155 |

The following interactions do not Contribute to the prediction and were eliminated in a stepwise process:

nviscode:hmscore

nviscode:mmscore

nviscode:nbatglobbl

nviscode:pteducat

The following predictors do not contribute to the prediction and were eliminated stepwise:

pteducation

hmscore (Hachinski score)

ptgender

mmscore

According to the above-described steps, the following simpler model is produced:

Linear mixed-effects model fit by REML

Data: MCIba_0

| AIC | BIC | logLik |
|---|---|---|
| 1005.021 | 1094.557 | −485.5104 |

Random effects:

| Formula: | ~1 + nviscode \| rid | |
|---|---|---|
| Structure: | General positive-definite, Log-Cholesky parametrization | |
| | StdDev | Corr |
| (Intercept) | 0.18855028 | (Intr) |
| nviscode | 0.06763452 | 0.665 |
| Residual | 0.24999246 | |

Fixed effects: nbatglob ~ vsbmicat2 + nviscode + napgen + ptage + faqtotal +
totalmodbl + nbatglobbl + vsbmicat2:nviscode + nviscode:napgen +
nviscode:totalmodbl

| | | | | | |
|---|---|---|---|---|---|
| | Value | Std. Error | DF | t-value | p-value |
| (Intercept) | 0.5517950 | 0.18082015 | 1065 | 3.05162 | 0.0023 |
| vsbmicat2high | −0.0671974 | 0.03829876 | 367 | −1.75456 | 0.0802 |
| vsbmicat2obese | −0.0404127 | 0.05358203 | 367 | −0.75422 | 0.4512 |
| nviscode | 0.0121559 | 0.02183583 | 1065 | 0.55670 | 0.5779 |
| napgen | 0.0340903 | 0.02620448 | 367 | 1.30093 | 0.1941 |
| ptage | −0.0038468 | 0.00227450 | 367 | −1.69125 | 0.0916 |
| faqtotal | −0.0087170 | 0.00375371 | 367 | −2.32225 | 0.0208 |
| totalmodbl | −0.0028959 | 0.00340943 | 367 | −0.84939 | 0.3962 |
| nbatglobbl | 0.9747272 | 0.03045660 | 367 | 32.00381 | 0.0000 |
| vsbmicat2high:nviscode | 0.0211988 | 0.01365817 | 1065 | 1.55209 | 0.1209 |
| vsbmicat2obese:nviscode | 0.0546617 | 0.02002082 | 1065 | 2.73024 | 0.0064 |
| nviscode:napgen | −0.0353962 | 0.00931502 | 1065 | −3.79991 | 0.0002 |
| nviscode:totalmodbl | −0.0055600 | 0.00103651 | 1065 | −5.36418 | 0.0000 |

Standardized Within-Group Residuals:

| | | | | |
|---|---|---|---|---|
| Min | Q1 | Med | Q3 | Max |
| −5.5597357723 | −0.5603156605 | −0.0002501770 | 0.5339628395 | 3.3359298640 |

Number of Observations: 1445
Number of Groups: 375
Random Effects:

| | | | |
|---|---|---|---|
| Level: rid | | | |
| | lower | est. | upper |
| sd((Intercept)) | 0.14500809 | 0.18855028 | 0.24516706 |
| sd(nviscode) | 0.05361047 | 0.06763452 | 0.08532715 |
| cor((Intercept), nviscode) | −0.28172862 | 0.66478431 | 0.95556777 |

Within-group standard error:

| | | |
|---|---|---|
| lower | est. | upper |
| 0.2376749 | 0.2499925 | 0.2629484 |

Interaction of BMI with time means: overweight patients decrease less rapidly or even get better. For obese patients, this effect occurs more strongly.

Interaction of APOE with time means: patients with E4 alleles decrease more rapidly.

Interaction of ADAScog score with time means: patients with higher baseline values of the ADAScog score(=poorer Performance) have a steeper decrease.

The residuals of the model show no deviation from the normal distribution; a transformation of the dependent variables is not shown.

The overall error of this model (standard deviation of an individual value) is:

0.32 (6 months) to 0.51 (36 months)

Lower limits for this overall error:

0.28 (6 months) to 0.43 (36 months)

Upper limits for this overall error:

0.37 (6 months) to 0.63 (36 months)

For comparison: the standard deviation of all global scores (6 to 36 months) is 0.86

The graphs according to FIGS. 5a to 5f illustrate the effect of each predictor over time. In each graph, not only time (in periods of six months) but also a variable is varied (different lines). In the case of the varying variables, use is made of quartiles and median, or typical values. In the case of all other variables which do not vary in the graph concerned, use is made of the following medians or typical values.
BMI: normal
APOE: 0 E4-Allele
Age:
faqtotal=2
ADAScog: totalmodbl=18.3
Neurobat: nbatglobbl=−1

FIG. 5a shows the predicted score as a function of time for three-different values of the BMI.

FIG. 5b shows the predicted score as a function of time for three different values of APO E4.

FIG. 5c shows the predicted score as a function of time for three different values of age.

FIG. 5d shows the predicted score as a function of time for three different values of FAQtotal.

FIG. 5e shows the predicted score as a function of time for three different values of ADAScog total (modified).

FIG. 5f shows the predicted score as a function of time for three different values of the baseline.

For each subject with complete predictor data, values are simulated according to the mixed model.

Here, initially logarithms of the standard deviations for intercept and slope are simulated per subject. Using the standard deviations obtained in this way, random effects for the intercept and the slope are generated. Furthermore, vector of fixed effects according to the parameter estimations and the covariance matrix thereof is generated for each subject In addition, an error term is generated for each subject and each time point.

These data were generated completely for visits 1-4. The observed data are, not complete. A comparison for each data point is therefore not possible.

The simulated data at no point completely agree with the observed data. However, their overall distribution is similar to that for the observed data. The following distributions were calculated:

Observed Data According to ADIN Data:

| Min. | 1st Qu. | Median | Mean | 3rd Qu. | Max. | NA's |
|---|---|---|---|---|---|---|
| −3.9520 | −1.4960 | −0.9681 | −1.0110 | −0.4673 | 1.7420 | 20.0000 |

SD: 0.8296862

Simulated Data with Second Calculation Model:

| Min. | 1st Qu. | Median | Mean | 3rd Qu. | Max. |
|---|---|---|---|---|---|
| −3.3970 | −1.5340 | −0.9858 | −0.9937 | −0.3990 | 1.4310 |

SD: 0.7875737

The distributions of the observed and simulated data are compared in FIG. 6a and FIG. 6b in two histograms (in each case all visits included) and in FIG. 6c in QQ plots per visit.

The simulated data are determined from the model parameters and the predictors available at the start of the study. Upon application to a new study, the same model parameters, but the predictors of the new study participants, are used for the simulation.

1. A method for carrying out clinical studies for treating a disease of interest with the steps of:
defining a test group of test persons and determining baseline characteristics,
administering a treatment to be investigated over a predetermined period to the test persons of the test group,
determining at least once values of at least one predefined target criterion of the test persons of the test group up to the end of the predetermined period,
characterized by the further steps of
determining at least once values of the at least one predefined target criterion of control persons of a virtual control group, which had not received the treatment, up to the end of the predetermined period, wherein the values of the at least one predefined target criterion of the control persons are determined in the predetermined period by means of a prognosis model froth values of baseline characteristics of the control persons,
comparing the values, determined up to the end of the predetermined period, of the at least one predefined target criterion of the control persons with those of the test persons.

2. The method as claimed in claim 1, wherein additional control persons of a real control group receive a placebo treatment over an initial time span, wherein the values of the at least one predefined target criterion of the additional control persons of the real control group are determined after the end of the initial time span and are compared with values, determined after the end of this time span, of the at least one predefined target criterion of the control persons of the virtual control group.

3. The method as claimed in claim 2, wherein the prognosis model is corrected based on the comparison of the values.

4. The method as claimed in claim 1, wherein the values of the baseline characteristics of the control persons are defined based on values of the baseline characteristics of the test persons.

5. The method as claimed in claim 1, wherein the test group comprises a number of test persons which is adapted to the problem of the study, more particularly to the type of disease and intervention and optionally to the tolerance of the prognosis model.

6. The method as claimed in claim 1, wherein a ratio of at least 1:1 of the number of, control persons to number of test persons is used.

7. The method as claimed in claim 1, wherein the treatment to be investigated is a treatment of diseases having a presumably malign course, for example dementias, more particularly Alzheimer's disease.

8. The method as claimed in claim 1, wherein values of at least one or more predefined target criteria are determined and compared.

9. The method as claimed in claim 1, wherein the target criteria are typically selected from the group consisting of:
parameters of the central nervous system, more particularly neuropsychological performance characteristics,
subjective and objective dementia symptoms,
time to event (progression to dementia)
changes in the brain, more particularly shrinkages of the hippocampus as a whole and/or shrinkages of certain sections of the hippocampus or other brain regions, vascular pathology, and similar changes,
markers in the cerebrospinal fluid, such as, for example, Abeta, tau, quotients of Abeta and/or other markers,
the presence of pathological proteins, such as Abeta and/or tau, in other body fluids,
further biochemical and genetic markers,
psychiatric and motor abnormalities

10. The method as claimed in claim 1, wherein the baseline characteristics typically comprise at least one target criterion and/or are selected from the group consisting of:
age of the patient,
the presence of the E-4 allele of the apolipoprotein gene and/or other genetic or biochemical markers,
the intelligence recorded in childhood or adolescence or an equivalent thereof, the duration of education and/or the professional career,
life-style factors in middle age, for example diet, physical activity, sport and/or other activities,
clinical characteristics and diagnoses, such as obesity, hypertension, diabetes and/or hyperlipidemia, which may also be summarized in an overall clinical score,
traumatic events such as stroke and accidents which may temporarily or permanently influence brain function
functional parameters of the human heart or other organs of the human body,
personal characteristics, such as neuroticism and/or conscientiousness.

11. A method for establishing a prognosis model for clinical studies, characterized by the steps of:
a) collecting representative results from, clinical studies with untreated patients concerning the course of a disease of interest,
b) evaluating these results,
c) identifying at least one target criterion which is clinically relevant for the course of the disease of interest and can be used as a predefined target criterion in a subsequent study,
d) determining the change in the value of this at least one target criterion for a certain number of patients,
so that, by means of this determination in step d), it is possible to prepare a prognosis for the temporal change in the value of this target criterion based on values of baseline characteristics for a patient.

12. The method as claimed in claim 11, wherein results of a sufficient number of persons who were observed during a sufficiently long period of the preclinical phase of the disease concerned are collected and evaluated.

13. The method as claimed in claim 11, wherein at least one or more target criteria are identified.

14. The method as claimed in claim 11, wherein the target criteria are typically selected from the group consisting of:
parameters of the central nervous system, more particularly neuropsychological performance characteristics,
subjective and objective dementia symptoms,
time to event (progression to dementia)
changes in the brain, more particularly shrinkages of the hippocampus as a whole and/or shrinkages of certain sections of the hippocampus or other brain regions, vascular pathology, and similar changes,
markers in the cerebrospinal fluid, such as, for example, Abeta, tau, quotients of Abeta and/or other markers,
the presence of pathological proteins, such as Abeta and/or tau, in other body fluids,
further biochemical and genetic markers,
psychiatric and motor abnormalities.

15. The method as claimed in claim 11, wherein the baseline characteristics typically comprise at least one target criterion and/or are selected from the group consisting of:
age of the patient,
the presence of the E-4 allele of the apolipoprotein gene and/or other genetic or biochemical markers,
the intelligence recorded in childhood or adolescence or an equivalent thereof, the duration of education and/or the professional career,
life-style factors in middle age, for example diet, physical activity, sport and/or other activities,
clinical characteristics and diagnoses, such as obesity, hypertension, diabetes and/or hyperlipidemia, which may also be summarized in an overall clinical score,
traumatic events, such as stroke, and accidents which may temporarily or permanently influence brain function
functional parameters of the human heart or other organs of the human body,
personal characteristics, such as neuroticism and/or conscientiousness.

16. The method as claimed in claim 12, wherein at least one or more target criteria are identified.

17. The method as claimed in claim 12, wherein the target criteria are typically selected from the group consisting of:
parameters of the central nervous system, more particularly neuropsychological performance characteristics,
subjective and objective dementia symptoms,
time to event (progression to dementia)
changes in the brain, more particularly shrinkages of the hippocampus as a whole and/or shrinkages of certain sections of the hippocampus or other brain regions, vascular pathology, and similar changes, markers in the cerebrospinal fluid, such as, for example, Abeta, tau, quotients of Abeta and/or other markers,
the presence of pathological proteins, such as Abeta and/or tau, in other body fluids,
further biochemical and genetic markers,
psychiatric and motor abnormalities.

18. The method as claimed in claim 12, wherein the baseline characteristics typically comprise at least one target criterion and/or are selected from the group consisting of:
age of the patient,
the presence of the E-4 allele of the apolipoprotein gene and/or other genetic or biochemical markers,
the intelligence recorded in childhood or adolescence or an equivalent thereof, the duration of education and/or the professional career,
life-style factors in middle age, for example diet, physical activity, sport and/or other activities,
clinical characteristics and diagnoses, such as obesity, hypertension, diabetes and/or hyperlipidemia, which may also be summarized in an overall clinical score,
traumatic events, such as stroke, and accidents which may temporarily or permanently influence brain function
functional parameters of the human heart or other organs of the human body,
personal characteristics, such as neuroticism and/or conscientiousness.

19. The method as claimed in claim 13, wherein the target criteria are typically selected from the group consisting of:
parameters of the central nervous system, more particularly neuropsychological performance characteristics,
subjective and objective dementia symptoms,
time to event (progression to dementia)
changes in the brain, more particularly shrinkages of the hippocampus as a whole and/or shrinkages of certain sections of the hippocampus or other brain regions, vascular pathology, and similar changes,
markers in the cerebrospinal fluid, such as, for example, Abeta, tau, quotients of Abeta and/or other markers,
the presence of pathological proteins, such as Abeta and/or tau, in other body fluids,
further biochemical and genetic markers,
psychiatric and motor abnormalities.

20. The method as claimed in claim 13, wherein the baseline characteristics typically comprise at least one target criterion and/or are selected from the group consisting of:
age of the patient,
the presence of the E-4 allele of the apolipoprotein gene and/or other genetic or biochemical markers,
the intelligence recorded in childhood or adolescence or an equivalent thereof, the duration of education and/or the professional career,
life-style factors in middle age, for example diet, physical activity, sport and/or other activities,
clinical characteristics and diagnoses, such as obesity, hypertension, diabetes and/or hyperlipidemia, which may also be summarized in an overall clinical score,
traumatic events, such as stroke, and accidents which may temporarily or permanently influence brain function
functional parameters of the human heart or other organs of the human body,
personal characteristics, such as neuroticism and/or conscientiousness.
